(19) United States
(12) Patent Application Publication
(10) Pub. No.: US 2011/0137984 A1
(43) Pub. Date: Jun. 9, 2011

(54) METHOD AND APPARATUS FOR SUPPORTING MULTIMEDIA STREAMING SERVICE

(75) Inventors: Yong-gyoo KIM, Hanam-si (KR); Gil-yoon KIM, Suwon-si (KR); Soon-yong JEONG, Suwon-si (KR); Tae-sung PARK, Yongin-si (KR); Seung-seok HONG, Suwon-si (KR)

(73) Assignee: SAMSUNG ELECTRONICS CO., LTD., Suwon-si (KR)

(21) Appl. No.: 12/964,069

(22) Filed: Dec. 9, 2010

(30) Foreign Application Priority Data
Dec. 9, 2009 (KR) 10-2009-0121946

(51) Int. Cl. G06F 15/16

(52) U.S. Cl. 709/203

(57) ABSTRACT

A client apparatus and method using a multimedia streaming service supporting technology that controls streaming communication with a streaming server on the basis of a buffer level independently from a pause/resuming input of a user are provided. The method includes: measuring a buffer level of a buffer of a streaming client which temporarily stores streaming data received from a streaming server; and controlling, independently from a user's input, streaming communication with the streaming server according to the measured buffer level.

### CROSS-REFERENCE TO RELATED PATENT APPLICATION

This application claims priority from Korean Patent Application No. 10-2009-0121946, filed on Dec. 9, 2009 in the Korean Intellectual Property Office, the disclosure of which is incorporated herein in its entirety by reference.

### BACKGROUND

1. Field

Apparatuses and methods consistent with exemplary embodiments relate to a streaming playback apparatus and method for supporting a multimedia streaming service.

2. Description of the Related Art

Recently, streaming services that transmit moving images over the Internet or communication networks are becoming widely used.

Generally, a streaming service is a multimedia service that plays back multimedia data without storing the multimedia data in storage spaces of user terminals. Although streaming services are widely used in wired communication networks, streaming services are also used in wireless communication networks which they are useful in mobile communication terminals such as portable phones lacking a separate storage space.

Technology for implementing moving-image streaming may generally be divided into an image compression algorithm, an audio compression algorithm and a wired/wireless network protocol.

Moving image formats that are currently being used in a wired/wireless system by using image compression technology include Moving Picture Experts Group (MPEG) series formats such as MPEG-1, MPEG-2 and MPEG-4 which have been designated by the international ISO/IEC standard committee, and H.26x series formats such as H.261, H.263 and H.264 which have been designated by the international ITU-T standard committee.

Examples of audio compression algorithms being used include wired/wireless audio compression algorithms such as Musical Instrument Digital Interface (MIDI), MPEG Audio Layer-3 (MP3) and Advanced Audio Coding (AAC), Qualcomm Code Excited Linear Prediction (QCELP) and Enhanced Variable Rate Coder (EVRC) suitable for a wireless environment.

Examples of wired/wireless network protocols include a Transmission Control Protocol (TCP) in which a transmission speed is low but transmission reliability is high and a User Datagram Protocol (UDP) in which a transmission speed is high and transmission reliability is low. In a wireless environment where a low network speed and loss of packets occur frequently, a Real-time Transport Protocol (RTP) and an RTP Control Protocol (RTCP) suitable as a real-time protocol having the merits of the TCP and UDP may be used in an environment utilizing a real time service. Moreover, for adaptively coping with such a real time service, a Real-time Streaming Protocol (RTSP) and a Service Discovery Protocol (SDP) that are used when connecting sessions may be used.

FIG. 1 is a diagram for describing an operation of a related art streaming playback apparatus. Referring to FIG. 1, a related art streaming playback apparatus (for example, a streaming client apparatus) includes a user interface (UI), a play engine, an RTSP source module, an audio/video (A/V) decoder module, an A/V rendering module, and an A/V buffer. The UI receives a command from a user and transfers the received command to the play engine. The play engine controls and manages the modules. The RTSP source module requests from a server to stream data or to stop transmission. The A/V decoder module decodes a compressed audio/video frame. The A/V rendering module outputs audio/video to a speaker/screen. The A/V buffer compensates for delay and jitter that occur in a network through buffering.

When a user pushes a pause button of the UI, the play engine pauses the modules. That is, the A/V decoder module pauses a decoding operation, and the A/V rendering module pauses an output. The RTSP source module requests a streaming server to pause, receives a success message from the streaming server, and sends the success message to the play engine. The play engine receives success messages from all the modules and informs the user that streaming playback has been paused, through the UI. Even when streaming playback is resumed, an operation similar to a pause operation is performed.

In a real-time environment, transferring a user's control command for multimedia streaming data to a server, instead of a terminal, and executing the control command in real time may cause results that differ from a user's intention because of limitations due to communication delay.

When a terminal autonomously processes streaming data, a response to a user's request may be made within a very short time (for example, tens of milliseconds). However, when performing an operation in accordance with a communication protocol that sends a command to a streaming server and receives a success response through, for example, the RTSP source module, a relatively long time (for example, hundreds of milliseconds to several seconds) passes due to the delay of a communication system for a control command. Particularly, when a wireless channel state is not good or there is a large amount of network traffic, more delay occurs.

Moreover, when a pause is made and then resuming is performed, the same frame sent before the pause is repeated in data transmitted or a frame is lost, thereby deteriorating A/V quality. Particularly, when a user repeats pausing and resuming within a short period of time, audio and video qualities deteriorate even more.

### SUMMARY

Exemplary embodiments provide a streaming playback method and apparatus, which efficiently provide a multimedia streaming service.

According to an aspect of an exemplary embodiment, there is provided a method for a streaming client to support a multimedia streaming service, the method including: measuring a buffer level of a buffer of the streaming client which temporarily stores streaming data received from a streaming server; and controlling, independently from a user's input, streaming communication with the streaming server on the basis of the measured buffer level.

The controlling the streaming communication may include requesting a pausing of the streaming communication to the streaming server when the buffer level, which is measured while the streaming communication with the streaming server is being performed, is greater than or equal to a threshold value.

The controlling the streaming communication may include requesting a resuming of the streaming communication to the streaming server when the buffer level, which is measured while the streaming communication with the streaming server is paused, is less than or equal to a threshold value.

The controlling the streaming communication may include controlling decoding of the streaming data, independently of the controlling the streaming communication with the streaming server, according to the user's input, when the user's input requesting pause or resuming of multimedia playback is received in a case where the measured buffer level is within a predetermined range.

According to an aspect of another exemplary embodiment, there is provided a computer-readable recording medium storing a program for executing the method above in a computer.

According to an aspect of another exemplary embodiment, there is provided a streaming client apparatus supporting multimedia streaming service, the streaming client apparatus including: a buffer level measurement unit which measures a buffer level of a buffer which temporarily stores streaming data received from a streaming server; and a streaming controller which controls, independently from a user's input, streaming communication with the streaming server on the basis of the measured buffer level.

The streaming controller may request pausing of the streaming communication to the streaming server when the measured buffer level, which is measured while the streaming communication with the streaming server is being performed, is greater than or equal to a threshold value.

The streaming controller may request resuming the streaming communication to the streaming server when the measured buffer level, which is measured while the streaming communication with the streaming server is paused, is less than or equal to a threshold value.

The streaming controller may control decoding of multimedia data, independently of controlling the streaming communication with the streaming server, according to the user's input, when the user's input requesting pause or resuming of multimedia playback is received and the measured buffer level is within a predetermined range.

According to an aspect of another exemplary embodiment, there is provided a multimedia streaming system including: a streaming server which transmits streaming data; and a streaming client apparatus which receives the streaming data from the streaming server, the streaming client apparatus including: a buffer level measurement unit which measures a buffer level of a buffer which temporarily stores the received streaming data, and a streaming controller which controls, independently from a user's input to the streaming client apparatus, streaming communication with the streaming server according to the measured buffer level.

### BRIEF DESCRIPTION OF THE DRAWINGS

The above and other aspects will become more apparent by describing in detail exemplary embodiments with reference to the attached drawings in which:

FIG. 1 is a diagram for describing the operation of a related art streaming playback apparatus;

FIG. 2 is a flowchart illustrating a method of supporting a multimedia streaming service, according to an exemplary embodiment;

FIG. 3 is a flowchart illustrating a method of controlling streaming communication in a streaming playback apparatus, according to an exemplary embodiment;

FIG. 4 is a graph for describing a method of controlling streaming communication according to an exemplary embodiment; and

FIG. 5 is a diagram illustrating a structure of a streaming client apparatus according to an exemplary embodiment.

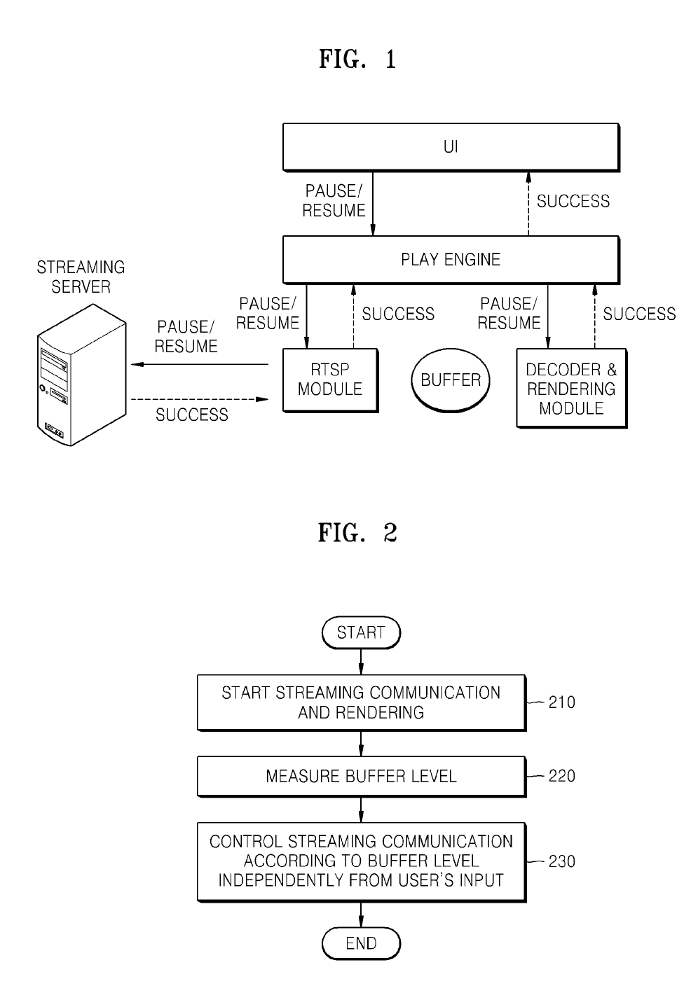

### DETAILED DESCRIPTION OF EXEMPLARY EMBODIMENTS

Exemplary embodiments will now be described with reference to the accompanying drawings, in which like reference numerals refer to like elements throughout.

FIG. 2 is a flowchart illustrating a method of supporting a multimedia streaming service, according to an exemplary embodiment. Referring to FIG. 2, in operation S210, a streaming playback apparatus starts streaming communication and rendering with a streaming server. That is, the streaming playback apparatus decodes in real time data received from the streaming server to output audio and video signals.

In operation S220, the streaming playback apparatus measures a buffer level of a buffer that temporarily stores data received from the streaming server.

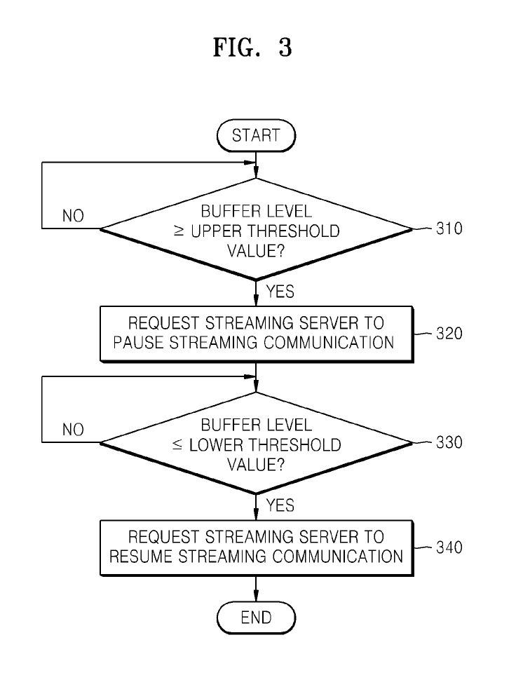

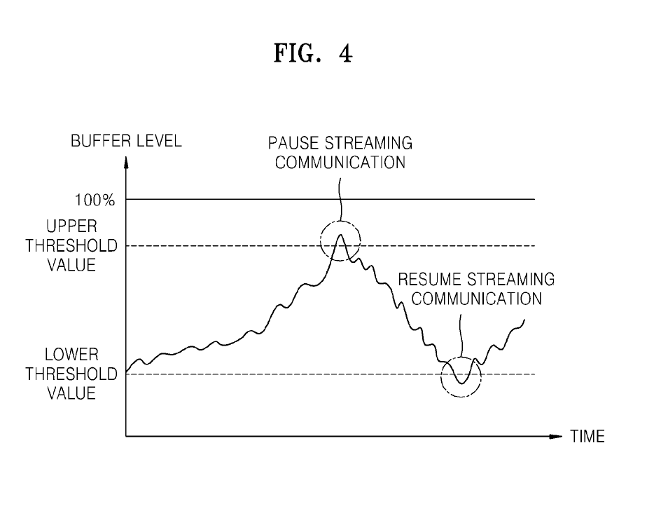

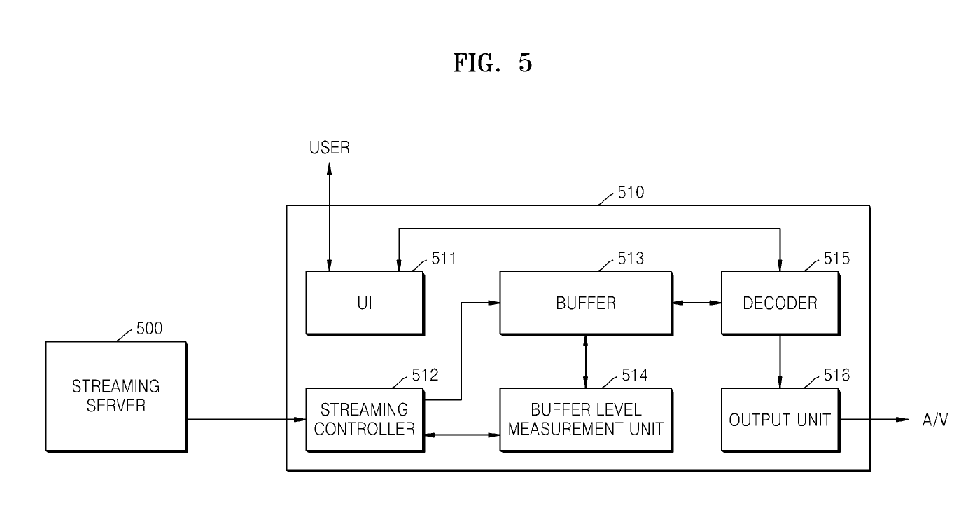

In operation S230, the streaming playback apparatus controls streaming communication with the streaming server on the basis of the buffer level measured in operation S220, independently of a user's input. That is, when the buffer level measured in operation S220 is within a predetermined range (e.g., a predetermined normal range), even if the user requests streaming to be paused or resumed through a user interface, the streaming playback apparatus merely controls the rendering of multimedia data, and streaming communication with the streaming server is paused or resumed independently of the user's input. A method of controlling streaming communication with the streaming server on the basis of a buffer level will be described below in detail with reference to FIGS. 3 and 4.

According to the present exemplary embodiment, communication with the streaming playback apparatus, i.e., between a streaming client and a streaming server, is controlled depending on only the local buffer level of the streaming playback apparatus irrespective of a user's input. Therefore, when a user's input requesting pause or playback is received, delay time is minimized, and the qualities of audio and video can be prevented from deteriorating.

FIG. 3 is a flowchart illustrating a method of controlling streaming communication in a streaming playback apparatus, according to an exemplary embodiment. Referring to FIG. 3, in operation S310, a streaming playback apparatus measures a buffer level while streaming communication is being performed and determines whether the measured buffer level is greater than or equal to an upper threshold value.

In operation S320, when the measured buffer level is determined to be greater than or equal to the upper threshold value, the streaming playback apparatus requests the streaming server to pause streaming communication.

In operation S330, the streaming playback apparatus measures a buffer level while streaming communication is paused and determines whether the measured buffer level is less than or equal to a lower threshold value.

In operation S340, when the measured buffer level is determined to be less than or equal to the lower threshold value, the streaming playback apparatus requests the streaming server to resume streaming communication.

FIG. 4 is a graph for describing a method of controlling streaming communication according to an exemplary embodiment. Referring to FIG. 4, an upper threshold value is a criterion for requesting the streaming server to stop the transmission of streaming data. That is, when a data size stored in the streaming buffer reaches the upper threshold value in a state where streaming communication is continuously being performed, the streaming playback apparatus according to the present exemplary embodiment automatically requests the streaming server to pause the transmission of the streaming data. Moreover, a lower threshold value is a criterion for requesting the streaming server to transmit the streaming data. That is, when the data size stored in the streaming buffer reaches the lower threshold value in a state where streaming communication is paused, the streaming playback apparatus automatically requests the streaming server to resume transmission of the streaming data.

When the storage capacity of the streaming buffer reaches a corresponding value, the streaming playback apparatus automatically requests the streaming server to transmit the streaming data.

For example, to facilitate a real time service, the upper threshold value may correspond to approximately 90% of a total buffer level, and the lower threshold value may be the same value as an initial buffer level (for example, which corresponds to 5 to 10 seconds).

In the streaming playback apparatus according to the present exemplary embodiment, when a user pushes a pause button, a decoding module and a rendering module for A/V data are merely paused, and streaming communication with the streaming server is independent from the user's input. Accordingly, since the streaming data is merely continuously received and stored in a buffer and not used, a buffer level rapidly reaches the upper threshold value, and the streaming playback apparatus automatically requests the streaming server to stop transmitting the streaming data.

Moreover, when the user again pushes a resume or play button, the streaming data stored in the buffer is decoded and rendered, and streaming communication with the streaming server is independent from the user's input. Accordingly, when streaming playback is continuously performed in a state where streaming communication is paused, data stored in the buffer is continuously used and a buffer level eventually reaches the lower threshold value. At this point, the streaming playback apparatus automatically requests the streaming server to resume transmission of the streaming data.

According to the present exemplary embodiment, since streaming communication between the streaming client and the streaming server is independent from a user's input corresponding to pausing and resuming, a response time for a user's request becomes faster.

Moreover, although a duration during which a playback is paused may be short or a user's input requesting pausing and resuming is frequently repeated, since the number of times that a command is sent to the streaming server is independent of the user's input and therefore reduced, the streaming playback apparatus according to an exemplary embodiment can decrease the deterioration of video and audio qualities that may occur when streaming playback is repeatedly paused and then resumed.

Moreover, when a clock driven in the streaming client differs from a clock driven in the streaming server or when network jitter is severe, overflow where data is stored in excess of a buffer level occurs. According to the present exemplary embodiment, however, overflow does not occur because streaming communication is controlled according to a buffer level, thereby preventing video and audio from deteriorating because of overflow.

FIG. 5 is a diagram illustrating a structure of a streaming client apparatus 510 according to an exemplary embodiment. Referring to FIG. 5, the streaming client apparatus 510 includes a UI 511, a streaming controller 512, a buffer 513, a buffer level measurement unit 514, a decoder 515, and an output unit 516.

The UI 511 receives commands such as pause and resume from a user and transfers the commands to the decoder 515.

The streaming controller 512 controls streaming communication with a streaming server 500 on the basis of a data size (i.e., a buffer level) stored in the buffer 513, independently from a user's input received through the user interface 511. That is, the streaming controller 512 merely controls streaming communication according to a buffer level, and does not send to the streaming server 500a request message, indicating a user's request to pause or resume streaming communication, which is inputted through the user interface 511.

The buffer 513 temporarily stores multimedia data that is received from the streaming server 500. The buffer level measurement unit 514 measures a data size stored in the buffer 513 and informs the streaming controller 512 of the measured data size.

The decoder 515 decodes multimedia data received from the streaming server 500, and the output unit outputs the data decoded by the decoder 515 as A/V signals to the user.

When the buffer level, which is measured by the buffer level measurement unit 514 while streaming communication with the streaming server 500 is continuously performed, is greater than or equal to a predetermined upper threshold value, the streaming controller 512 requests the streaming server to pause the streaming communication. Moreover, when the buffer level, which is measured by the buffer level measurement unit 514 while streaming communication with the streaming server 500 is paused, is less than or equal to a predetermined lower threshold value, the streaming controller 512 requests the streaming server to resume streaming communication.

In this way, the pause/resume command of the user received through the user interface 511 merely controls a decoding operation and a rendering operation, and does not control the streaming communication with the streaming server 500. Accordingly, the streaming playback apparatus can quickly respond to the pause/resume input of the user, even when the user frequently and repeatedly inputs such commands.

While not restricted thereto, exemplary embodiments can be written as computer programs and can be implemented in general-use or special-purpose digital computers that execute the programs using a computer readable recording medium.

Examples of the computer readable recording medium include magnetic storage media (e.g., ROM, floppy disks, hard disks, etc.) and optical recording media (e.g., CD-ROMs, or DVDs).

While the above-described exemplary embodiments have been particularly shown and described with reference to the drawings, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the invention is defined not by the detailed description of the exemplary embodiments but by the appended claims, and all differences within the scope will be construed as being included in the present invention.

What is claimed is:

1. A method for a streaming client to supporting a multimedia streaming service, the method comprising:
measuring a buffer level of a buffer of the streaming client which temporarily stores streaming data received from a streaming server; and
controlling, independently from a user's input, streaming communication with the streaming server according to the measured buffer level.

2. The method of claim 1, wherein the controlling the streaming communication comprises requesting the streaming server to pause the streaming communication when the buffer level, which is measured while the streaming communication with the streaming server is being performed, is greater than or equal to a threshold value.

3. The method of claim 1, wherein the controlling the streaming communication comprises requesting the streaming server to resume the streaming communication when the buffer level, which is measured while the streaming communication with the streaming server is paused, is less than or equal to a threshold value.

4. The method of claim 1, wherein the controlling the streaming communication comprises controlling decoding of the streaming data, independently of the controlling the streaming communication with the streaming server, according to the user's input, when the user's input requesting pausing or resuming of multimedia playback is received and the measured buffer level is within a predetermined range.

5. The method of claim 1, wherein the controlling the streaming communication comprises, when the user's input requests pausing multimedia playback of the streaming data and the measured buffer level is less than a threshold value, controlling the streaming communication to continue receiving the streaming data from the streaming server.

6. The method of claim 1, wherein the controlling the streaming communication comprises, when the user's input requests resuming multimedia playback of the streaming data and the measured buffer level is greater than a threshold value, controlling the streaming communication to not receive the streaming data from the streaming server.

7. The method of claim 1, wherein the user's input corresponds to a playback control of the streaming data.

8. The method of claim 1, wherein the streaming client is a mobile communication terminal.

9. A computer-readable recording medium storing a program executable by a computer to perform the method of claim 1.

10. A streaming client apparatus supporting a multimedia streaming service, the streaming client apparatus comprising:
a buffer level measurement unit which measures a buffer level of a buffer which temporarily stores streaming data received from a streaming server; and
a streaming controller which controls, independently from a user's input, streaming communication with the streaming server according to the measured buffer level.

11. The streaming client apparatus of claim 10, wherein the streaming controller requests the streaming server to pause the streaming communication when the buffer level, which is measured while the streaming communication with the streaming server is being performed, is greater than or equal to a threshold value.

12. The streaming client apparatus of claim 10, wherein the streaming controller requests the streaming server to resume the streaming communication when the buffer level, which is measured while the streaming communication with the streaming server is paused, is less than or equal to a threshold value.

13. The streaming client apparatus of claim 10, wherein the streaming controller controls decoding of the streaming data, independently of controlling the streaming communication with the streaming server, according to the user's input, when the user's input requesting pausing or resuming of multimedia playback is received and the measured buffer level is within a predetermined range.

14. A multimedia streaming system comprising:
a streaming server which transmits streaming data; and
a streaming client apparatus which receives the streaming data from the streaming server, the streaming client apparatus comprising:
a buffer level measurement unit which measures a buffer level of a buffer which temporarily stores the received streaming data, and
a streaming controller which controls, independently from a user's input to the streaming client apparatus, streaming communication with the streaming server according to the measured buffer level.
